(19) United States
(12) Patent Application Publication
(10) Pub. No.: US 2014/0051501 A1
(43) Pub. Date: Feb. 20, 2014

(54) Internet Gamification of a Marketing and Lifestyle Enhancement Process

(71) Applicant: Kevan Kenneth Boyles, Palm Beach, FL (US)

(72) Inventor: Kevan Kenneth Boyles, Palm Beach, FL (US)

(21) Appl. No.: 13/932,245

(22) Filed: Jul. 1, 2013

Related U.S. Application Data
(60) Provisional application No. 61/683,047, filed on Aug. 14, 2012.

(51) Int. Cl. A63F 13/12

(52) U.S. Cl. CPC A63F 13/12
USPC 463/25

(57) ABSTRACT

The gamification of unique marketing/lifestyle process for services providers and sales representatives. Through Internet social media and a gamified process, the service provider/sales representative is compelled to take specific action on a consistent basis that generates a measureable result, which enhances their bottom line and lifeline.

### CROSS REFERENCE TO RELATED APPLICATIONS

This application claims priority from U.S. Patent Application Ser. No. 61/683,047, entitled “Internet Gamification of a Marketing and Lifestyle Enhancement Process for the Professional and Nonprofessional Service Provider and Sales Industry”, filed on Aug. 14, 2012. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention pertains to generally to an online and computer data processing. The present invention more specifically relates to a system and method for internet gamification of a marketing and lifestyle enhancement process for the professional and nonprofessional service providers and sales industry.

### BACKGROUND OF THE INVENTION

The inability of professional and nonprofessional service providers and the sales industry to market their services/products and live their lives in a consistent and focused manner that produces increased, reliable, and predictable cash flow together with a higher quality of life.

Other systems/processes/services known in the prior art are not focused on motivating and producing consistent activity that generates predictable and reliable cash flow together with a higher quality of life.

Through social media and a gamified process, the service provider/sales representative is compelled, though the method and process of the present invention, to take specific action on a consistent basis that generates a measureable result and improves not only their bottom line but also their lifeline.

### DEFINITIONS

GAMIFICATION is the use of game design techniques and game mechanics to solve problems and engage audiences.

PLAYER or PLAYER is a service professional that is currently engaged in and using the method and/or system of the present invention.

HANDLE—the name or nickname under which a player is known.

REFERRAL ID is the person's Player ID (email address) who referred a new player to participate in the method and/or system of the present invention.

### SUMMARY OF THE INVENTION

The present invention is the gamification of a unique marketing and lifestyle process that solves the inability of professional and nonprofessional service providers and the sales industry to market their services/products in a consistent and focused manner that produces predictable and reliable cash flow together with an improved life. The present invention taught herein solves this problem.

The present invention allows the professional and nonprofessional service provider/sales representatives to consistently and competently market their unique abilities/value in such a way that generates a minimum of one new client/patient/file/sale a week for the service provider/sales representative.

The claimed invention differs from what currently exists because it uses the dynamics of Internet social media and game playing and design to focus and motivate the service provider/sales representative to consistently take certain actions that generate new business on a regular basis, which results in the increase and predictability of their cash flow together with an improved life.

The present invention is an improvement on what currently exists because current systems/processes/services do not focus and motivate the service provider/sales representative to take action on a consistent basis. The activities included in the systems/processes/services that currently exist do not compel and produce consistent, quantifiable results that affect the bottom line as well as the lifeline. Their suggested actions are often vague and there is usually no process to complete. Through social media and a gamified process, the service provider/sales representative is compelled to take specific action on a consistent basis that generates measureable results.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart illustrating the method of the present invention;

FIG. 2 is an illustrative screen image of a landing page in one website embodiment of the present invention;

FIG. 3 is an illustrative screen image of a home page in one website embodiment of the present invention;

FIGS. 4-7 are illustrative screen images of leaderboard pages in one website embodiment of the present invention;

FIG. 8 is an illustrative screen image of an action page in one website embodiment of the present invention;

FIGS. 9-12 are illustrative screen images of the action pages of the four core steps in one website embodiment of the present invention;

FIGS. 13-24 are illustrative screen images of additional action pages in one website embodiment of the present invention;

FIG. 25 is an illustrative screen image of a registration page in one website embodiment of the present invention;

FIG. 26 is an illustrative screen image of a badges page in one website embodiment of the present invention; and

FIG. 27 is an illustrative screen image of a results page in one website embodiment of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

The physical apparatus required to enable one embodiment of the present invention includes a web server; a web portal interface; a multi-player network; and an application server. Thus, the method of the present invention may also be recorded onto a CD, or any other recordable medium as well as being delivered electronically from a database to a computer, wherein the method embodied by the software that is recorded is then executed by a computer for use and transformation of the Internet browser and its contents. Now referring to the Figures, the embodiment of the method of the present invention is shown.

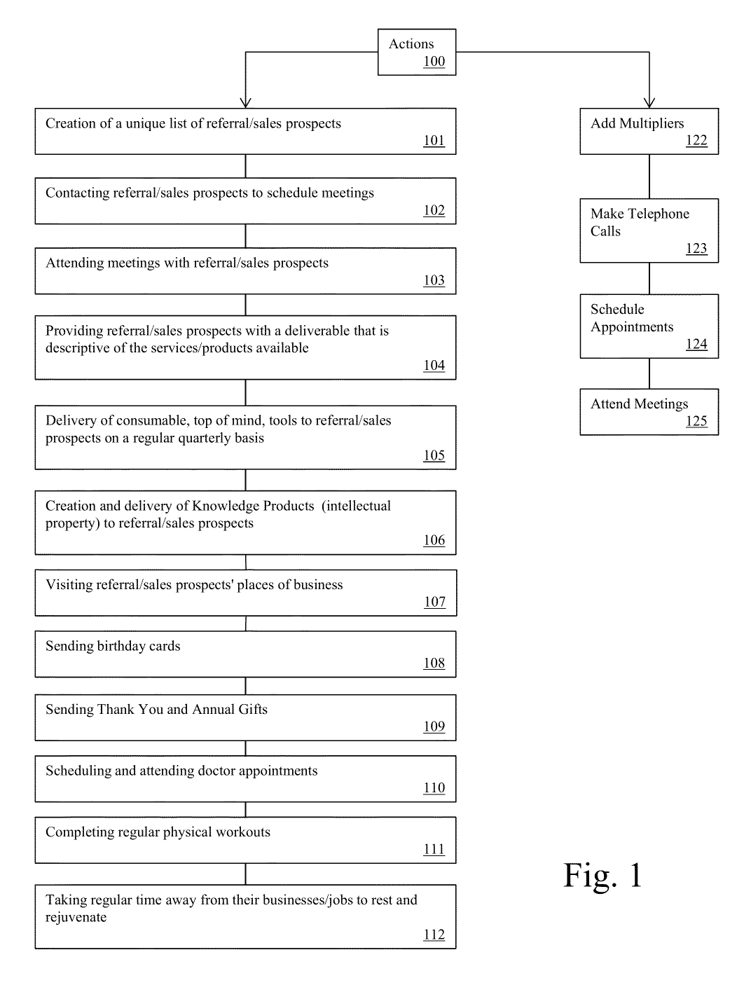

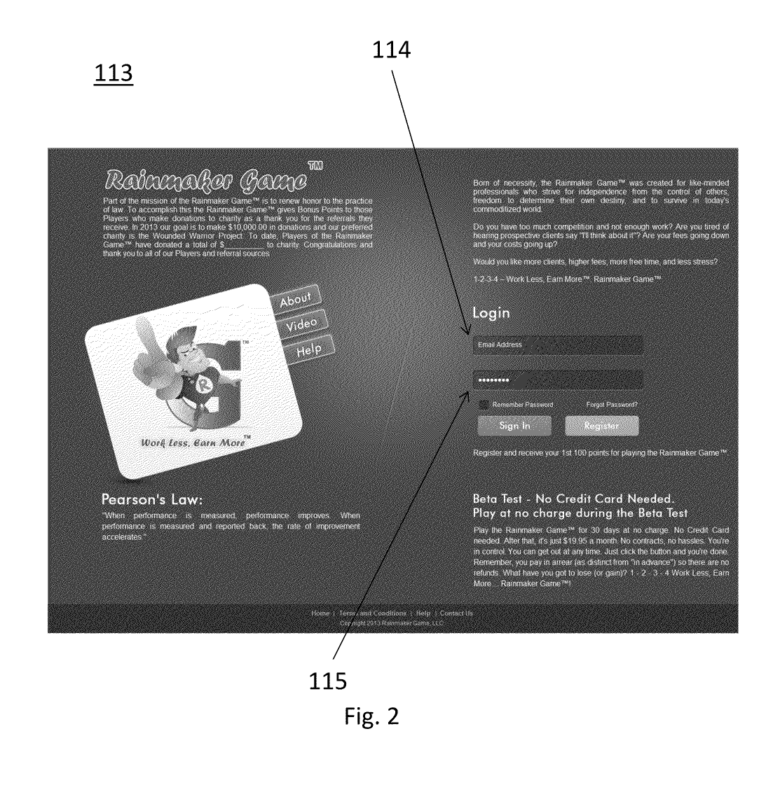

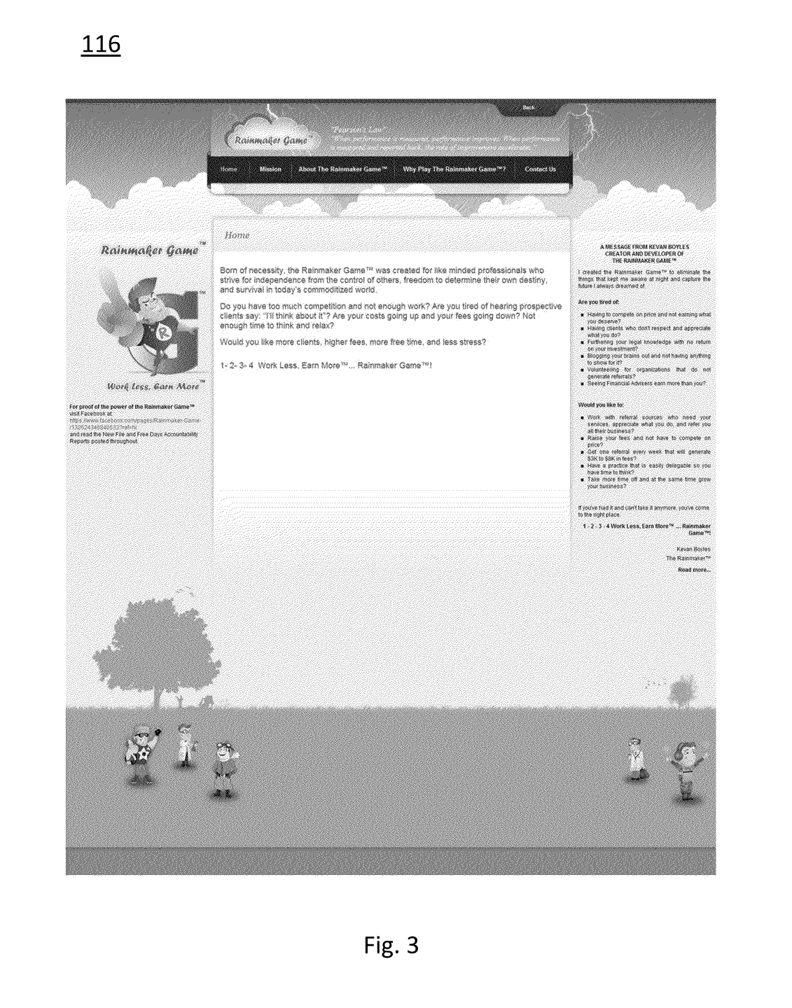

The present invention teaches a specific unique marketing process for delivering consistent and quantifiable results by scoring points for completing specific actions during particular time periods while competing against one's peers. The actions 100 include, but are not limited to, the following as show in FIG. 1: The creation of a unique list of referral/sales prospects 101; Contacting referral/sales prospects to schedule meetings 102; Attending meetings with referral/sales prospects 103; Providing referral/sales prospects with a deliverable that is descriptive of the services/products available 104; Delivery of consumable, top of mind, tools to referral/sales prospects on a regular quarterly basis 105; Creation and delivery of Knowledge Products (intellectual property) to referral/sales prospects 106; Visiting referral/sales prospects' places of business 107; Sending birthday cards 108; Sending Thank You and Annual Gifts 109; Scheduling and attending doctor appointments 110; Completing regular physical workouts 111; and Taking regular time away from their businesses/jobs to rest and rejuvenate 112.

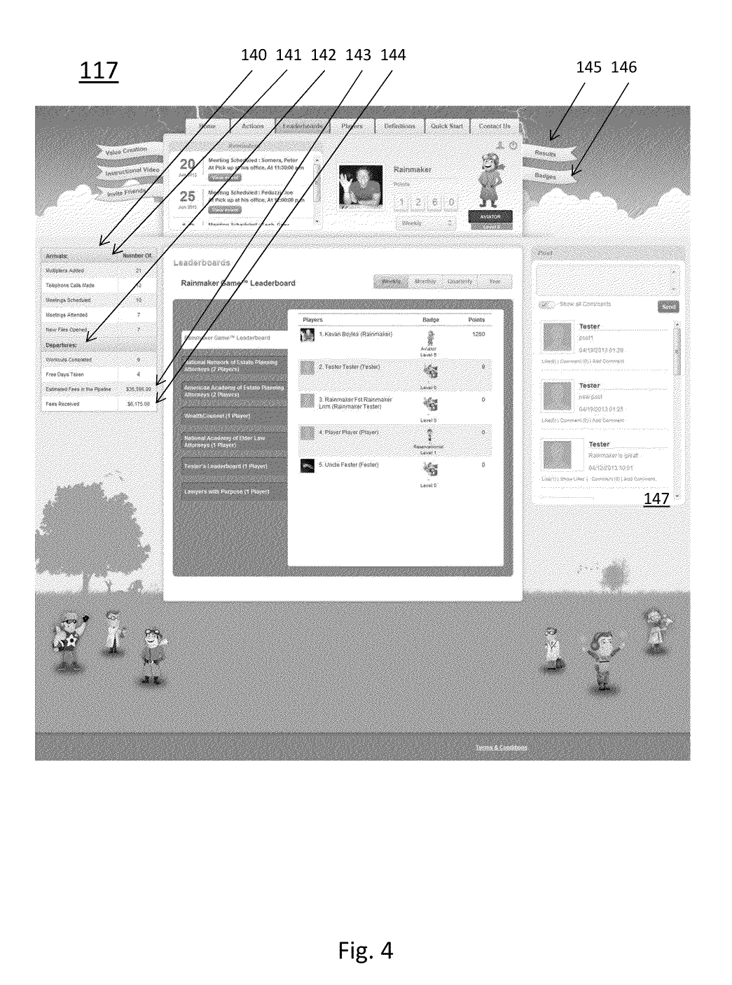

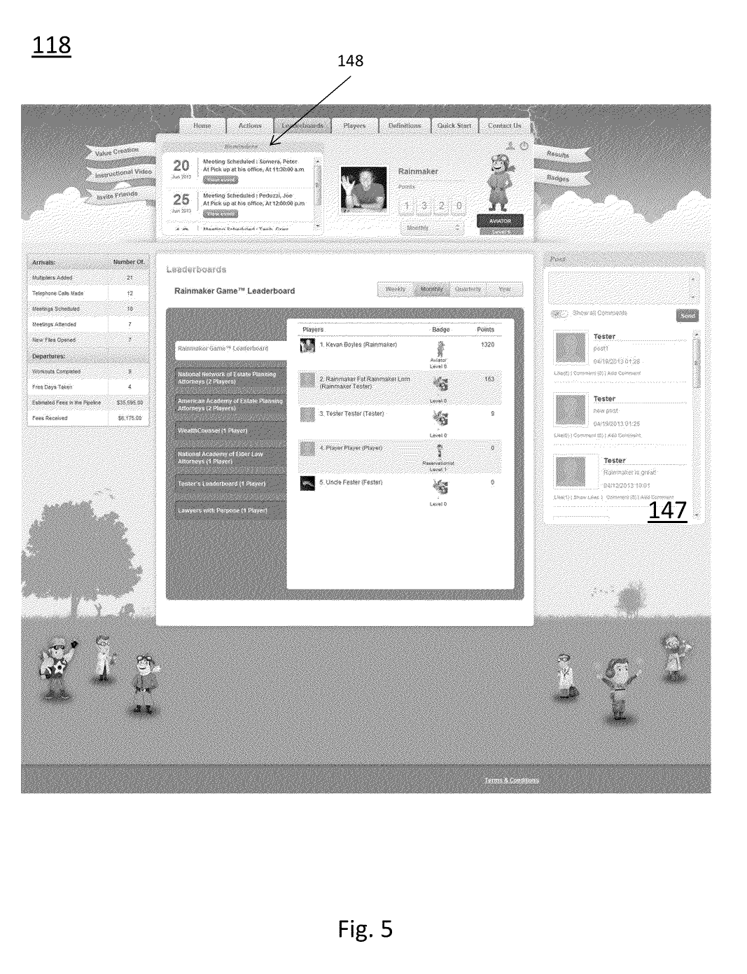

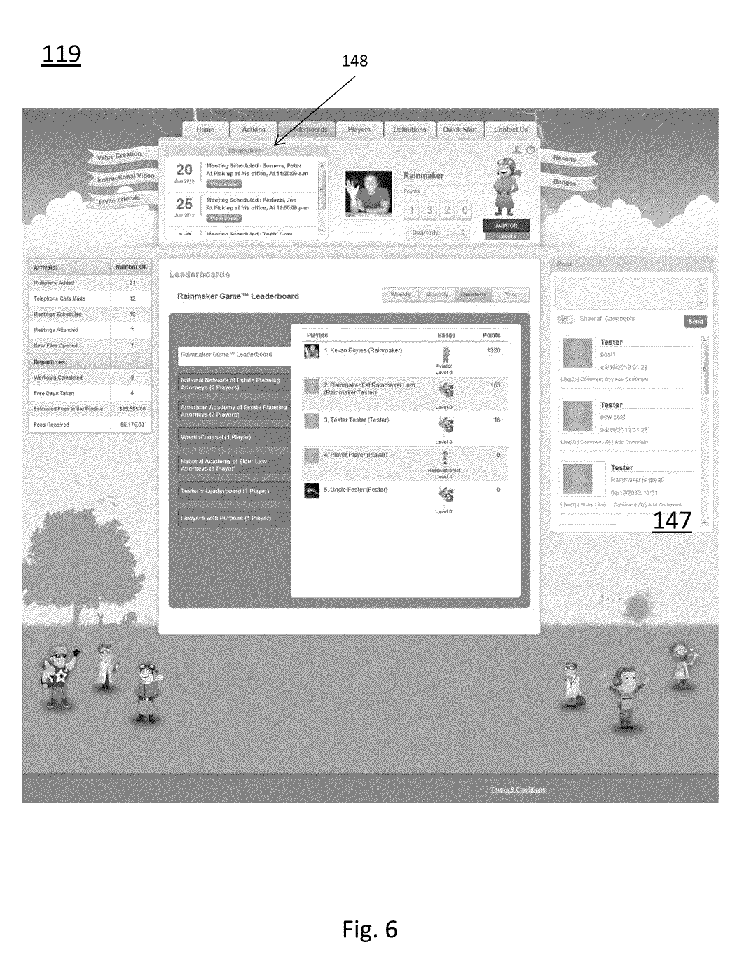

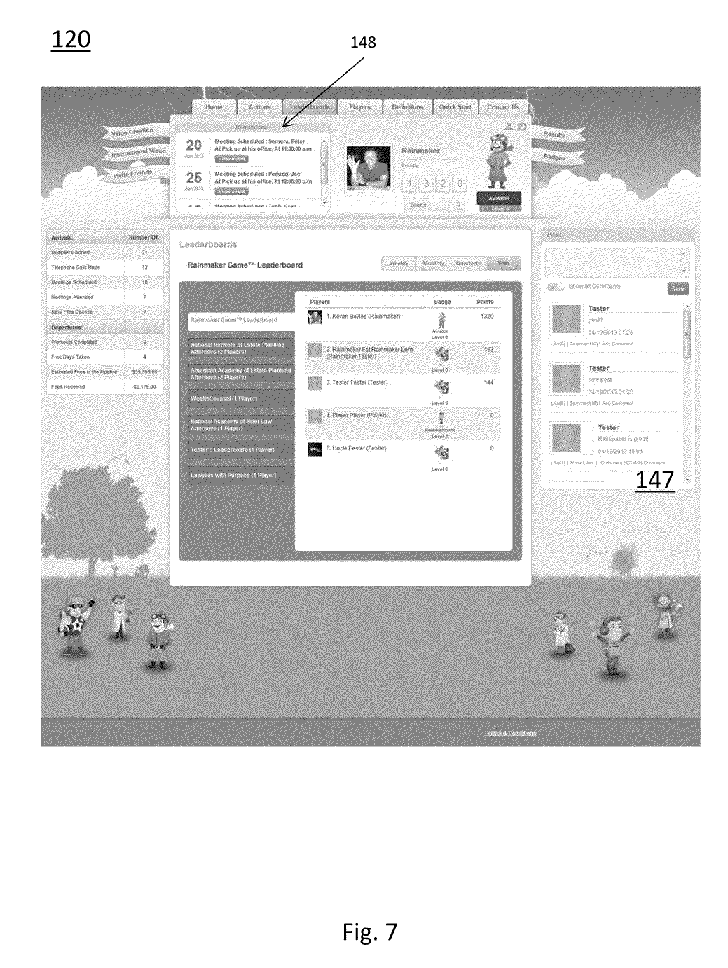

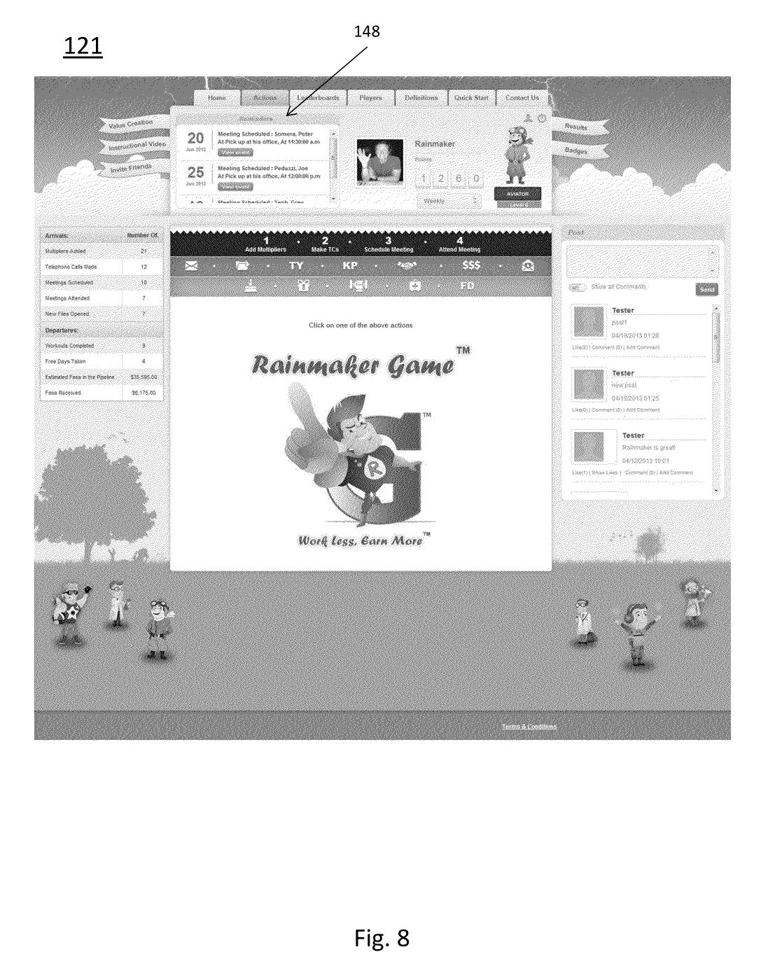

Points are scored, tabulated, and posted in various weekly 117, monthly 118, quarterly 119, and annual 120, real-time leaderboards as shown in FIGS. 4-7. Players compete between themselves, among different organizations, groups, etc. Each player can create unique leaderboards and invite other players. Badges are awarded to players as they progress through quantifiable levels of achievement and points are awarded on an exponential basis for achieving further levels, or more commonly known as “leveling up” in gaming.

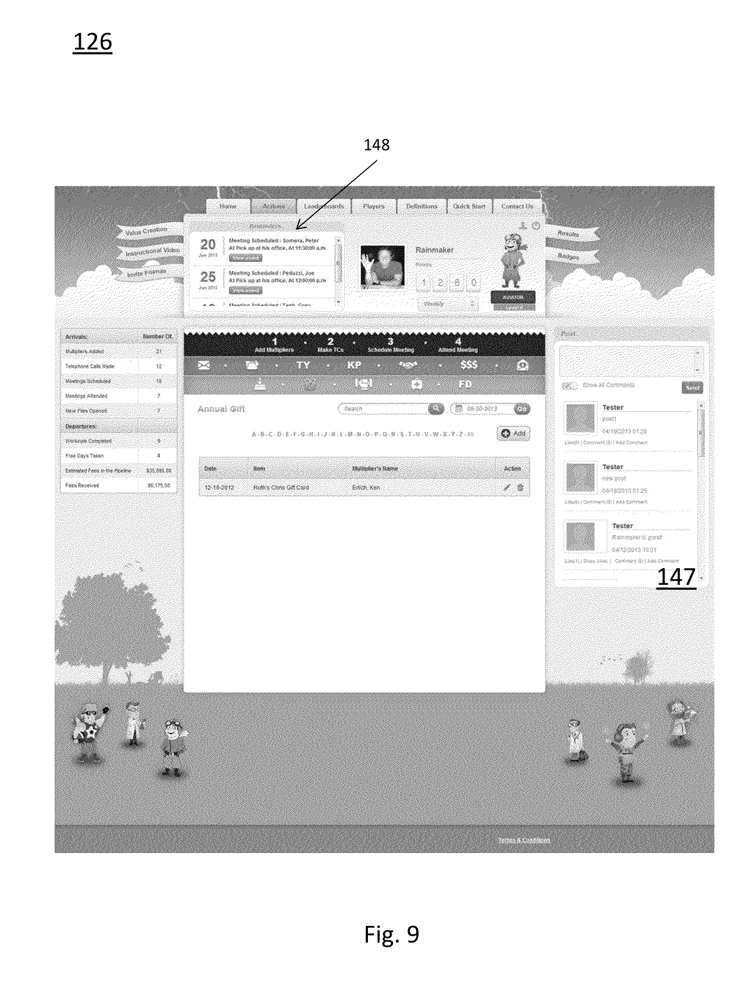

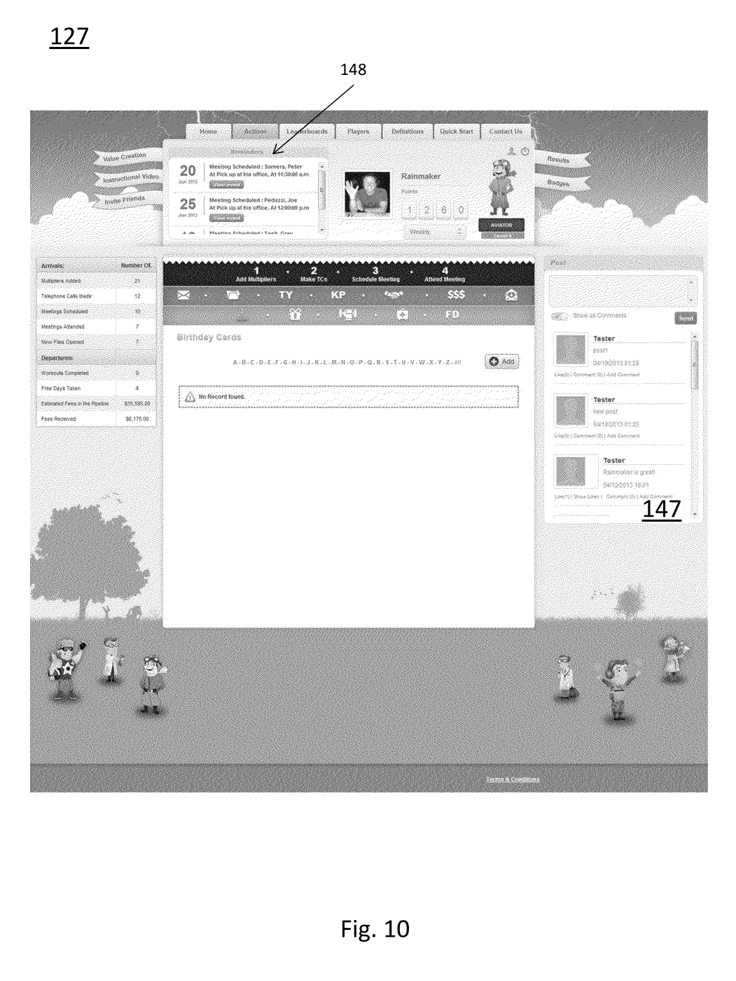

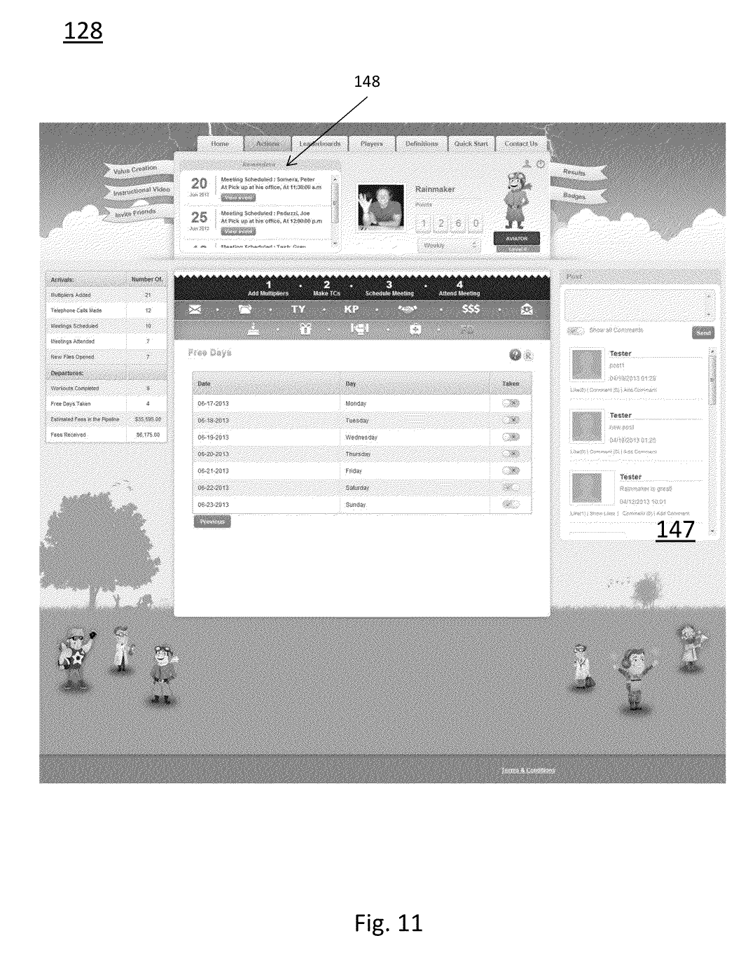

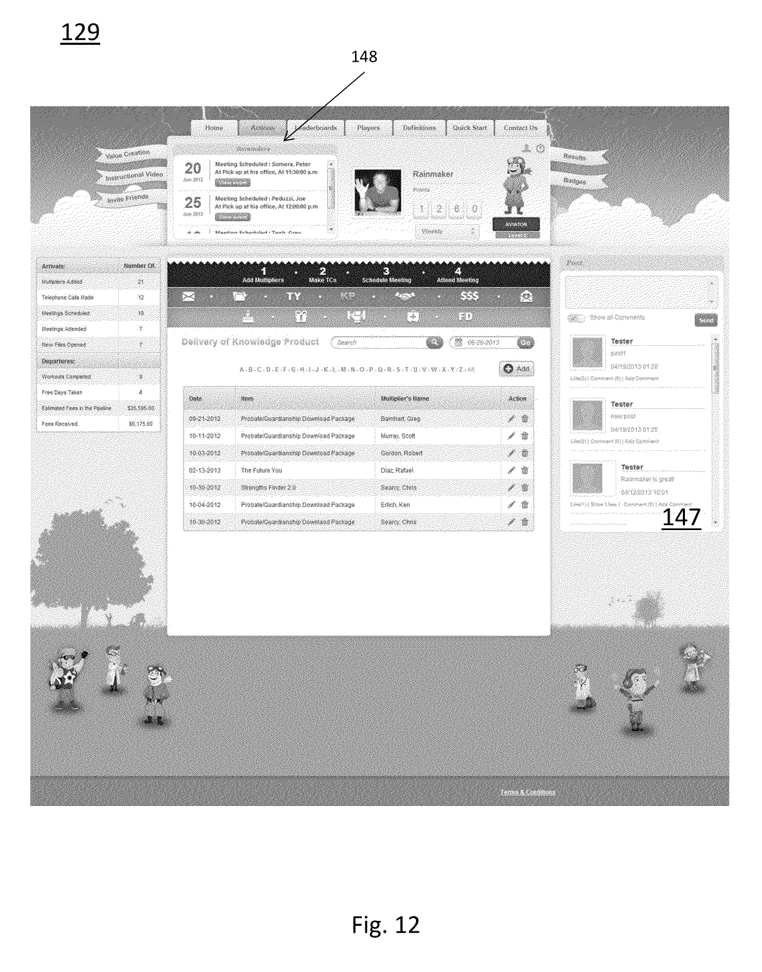

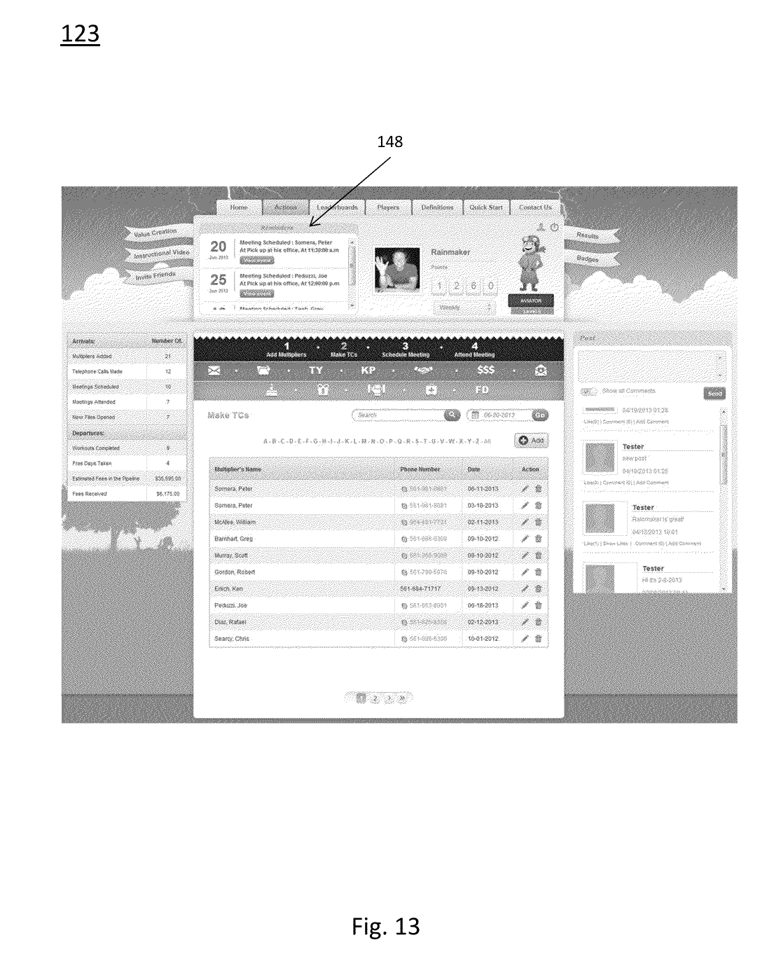

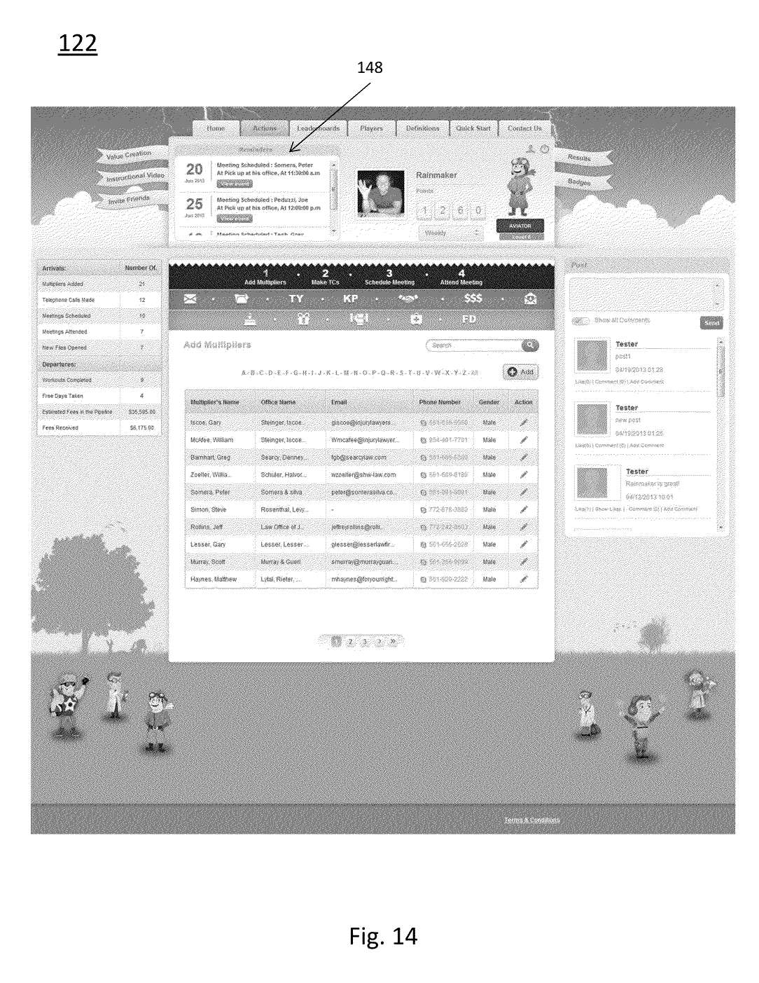

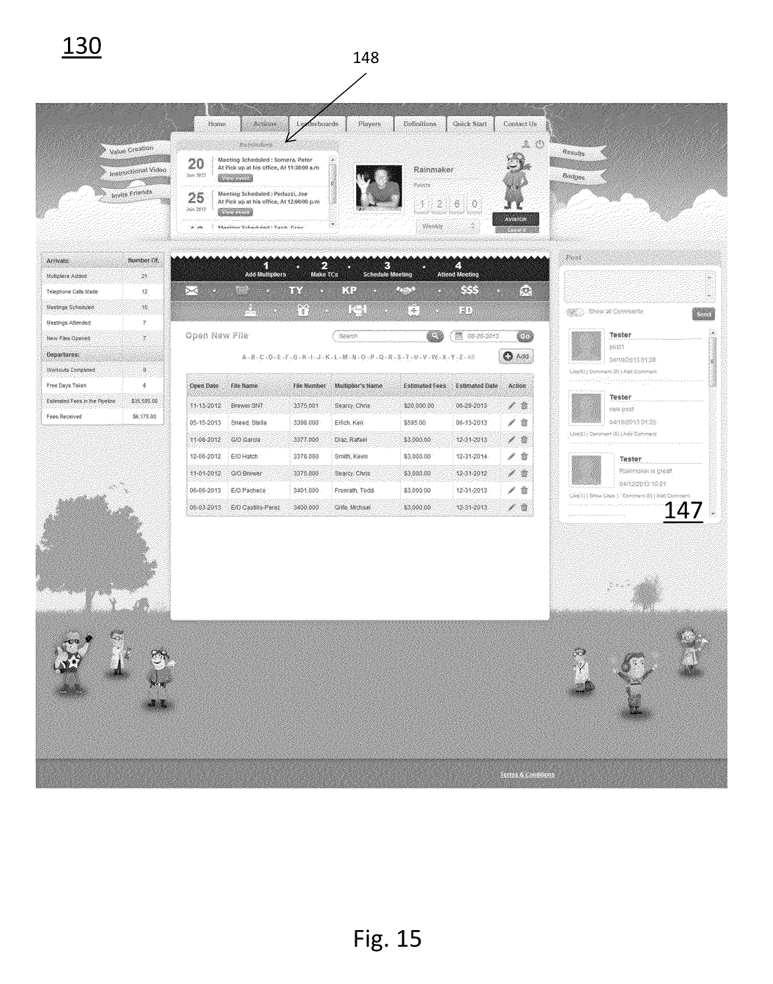

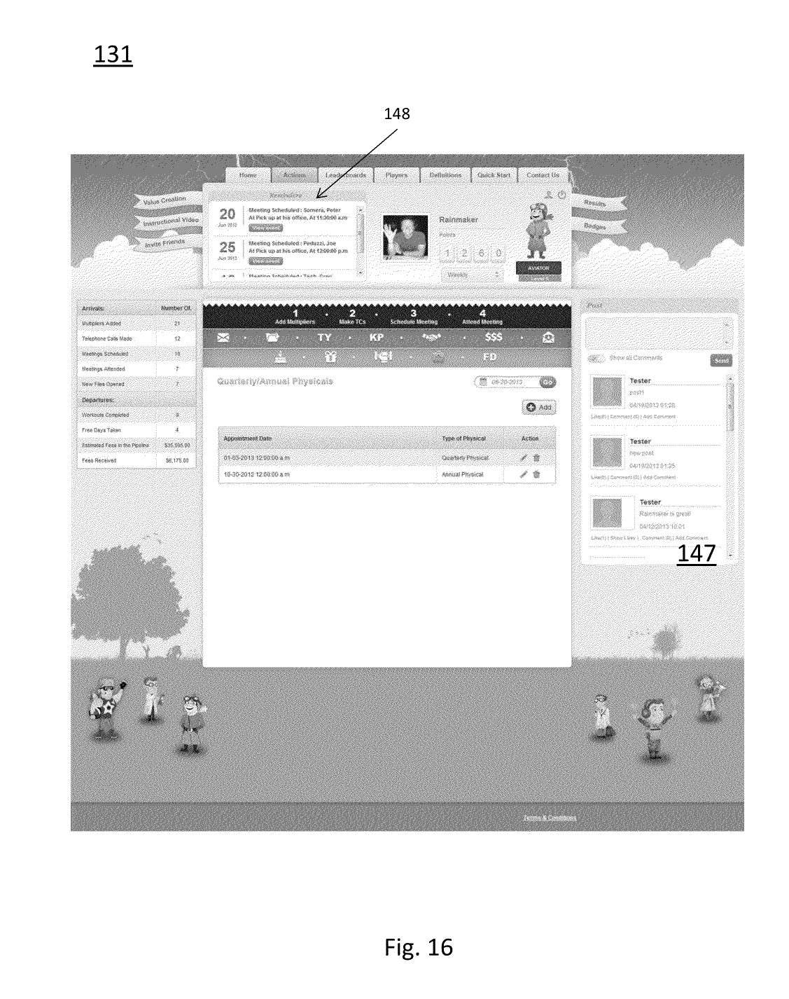

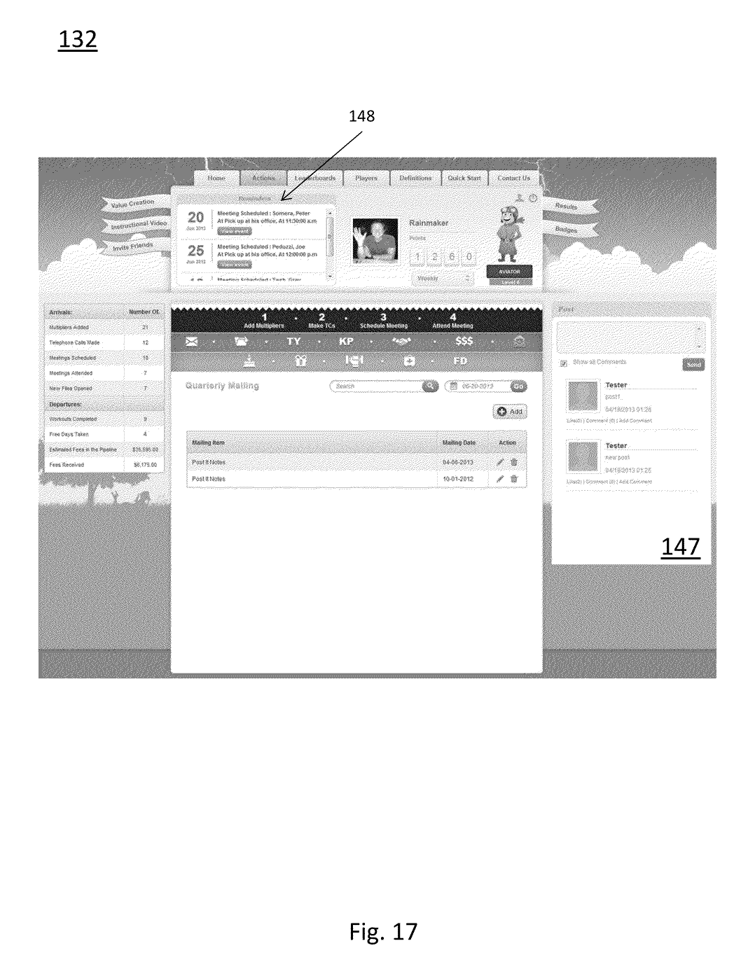

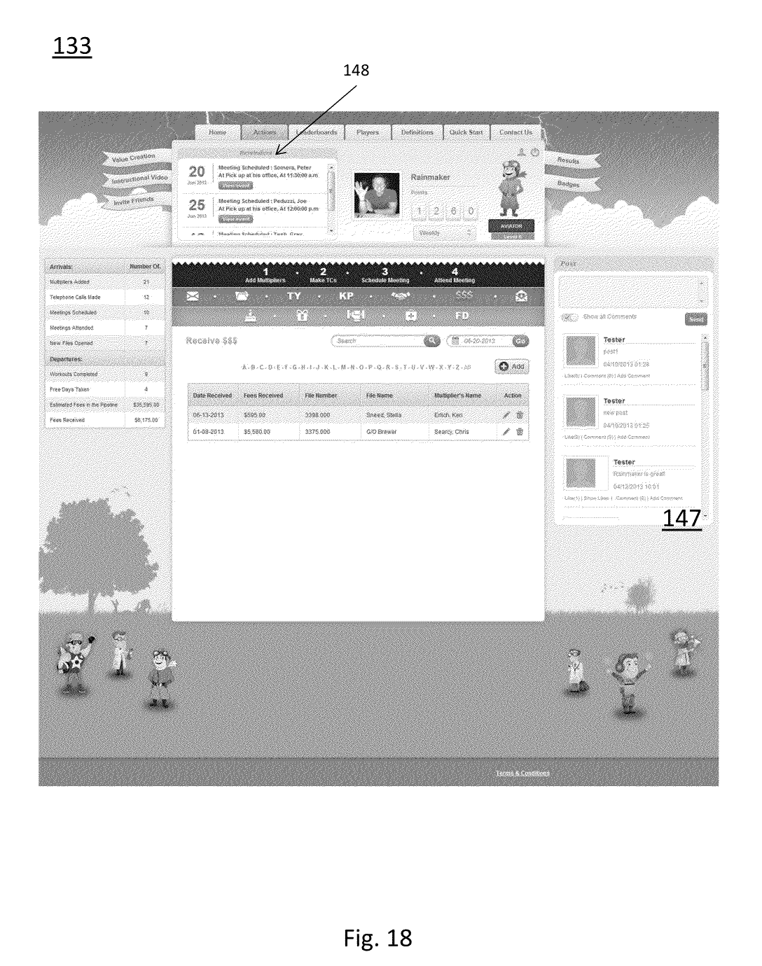

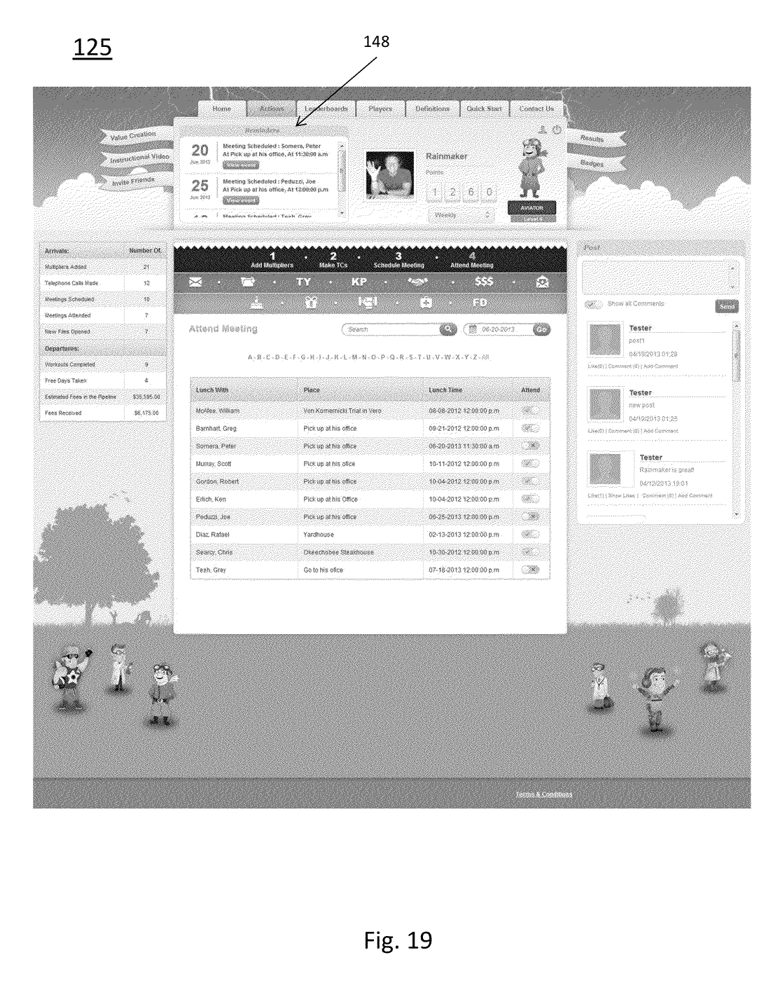

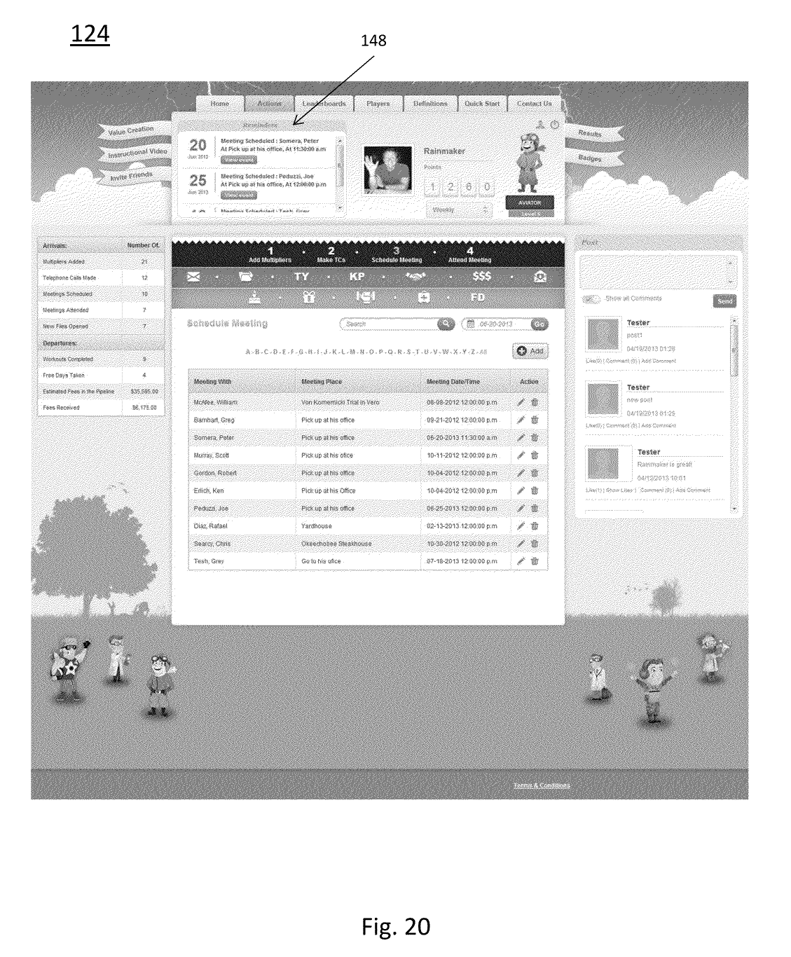

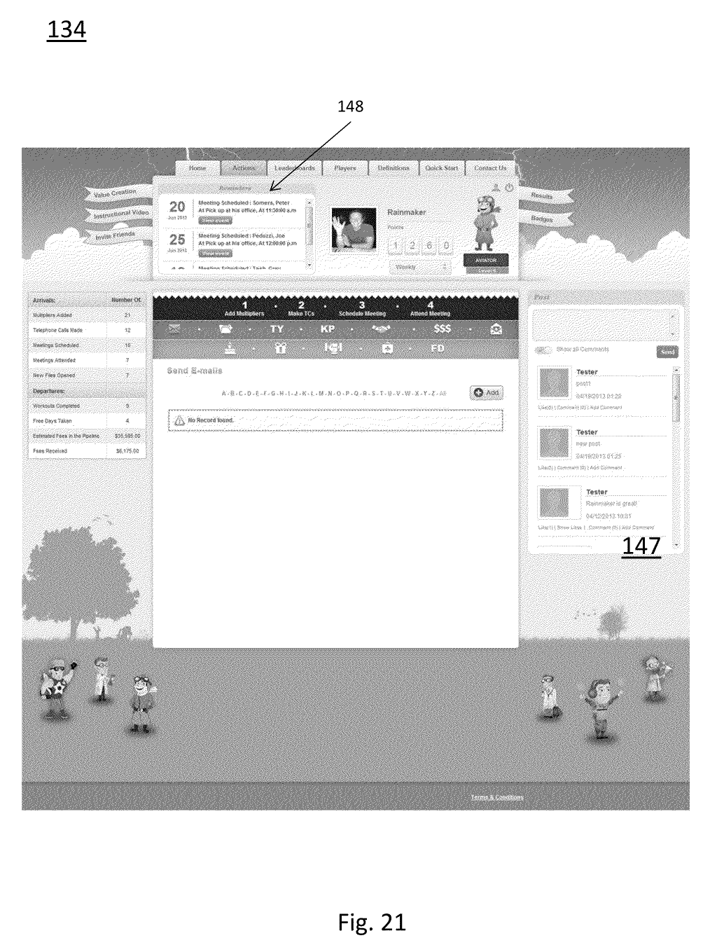

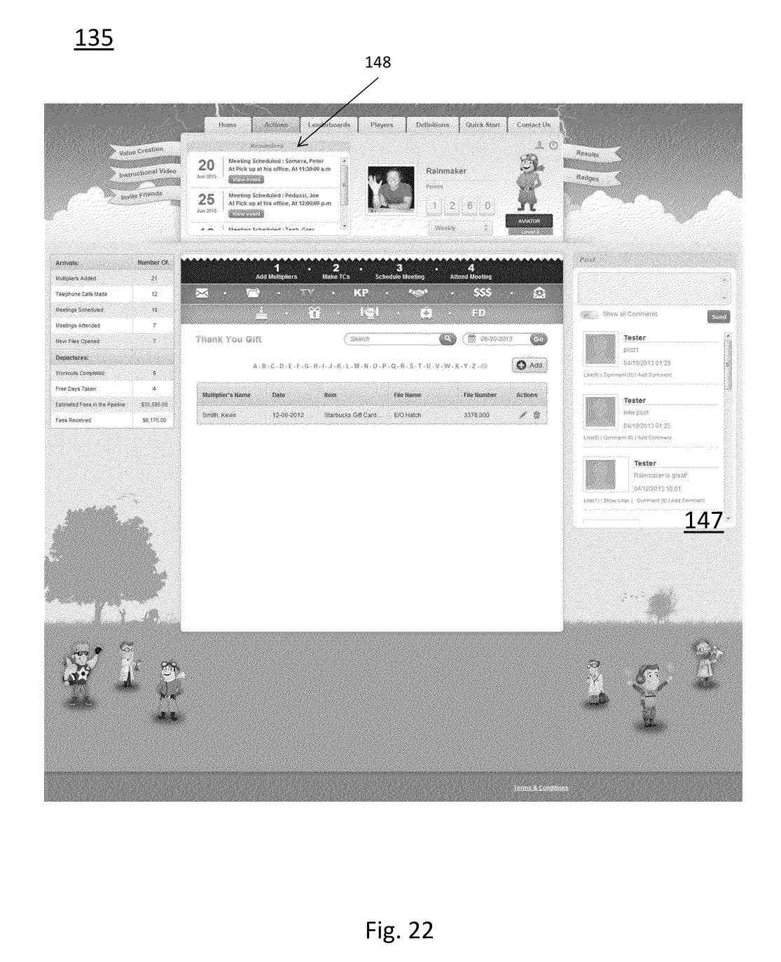

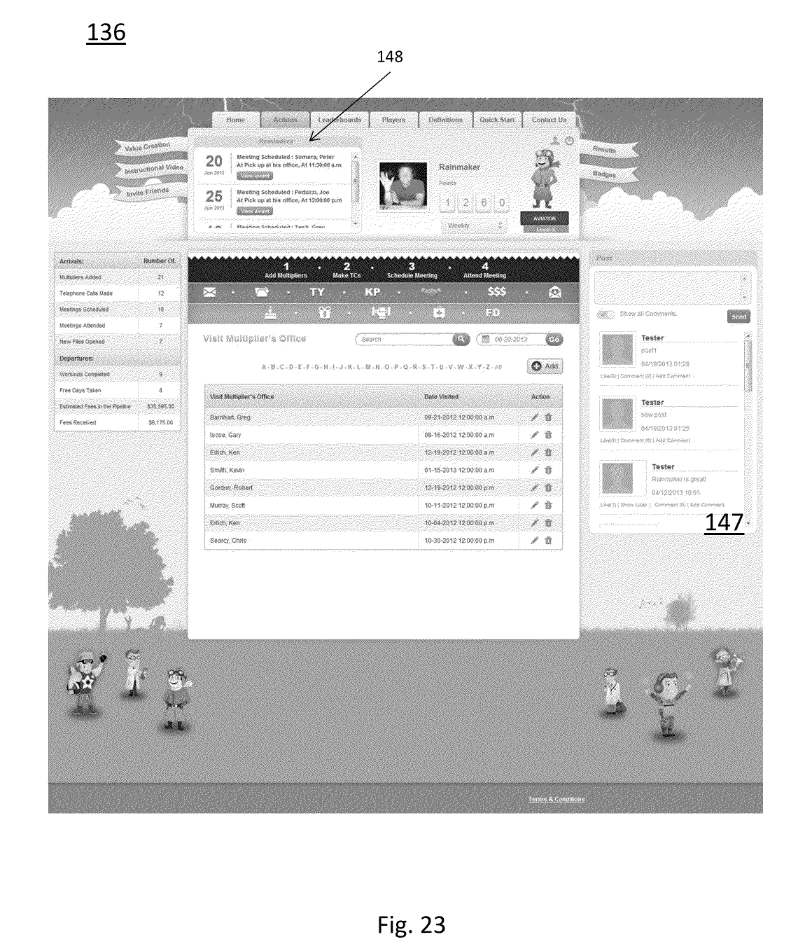

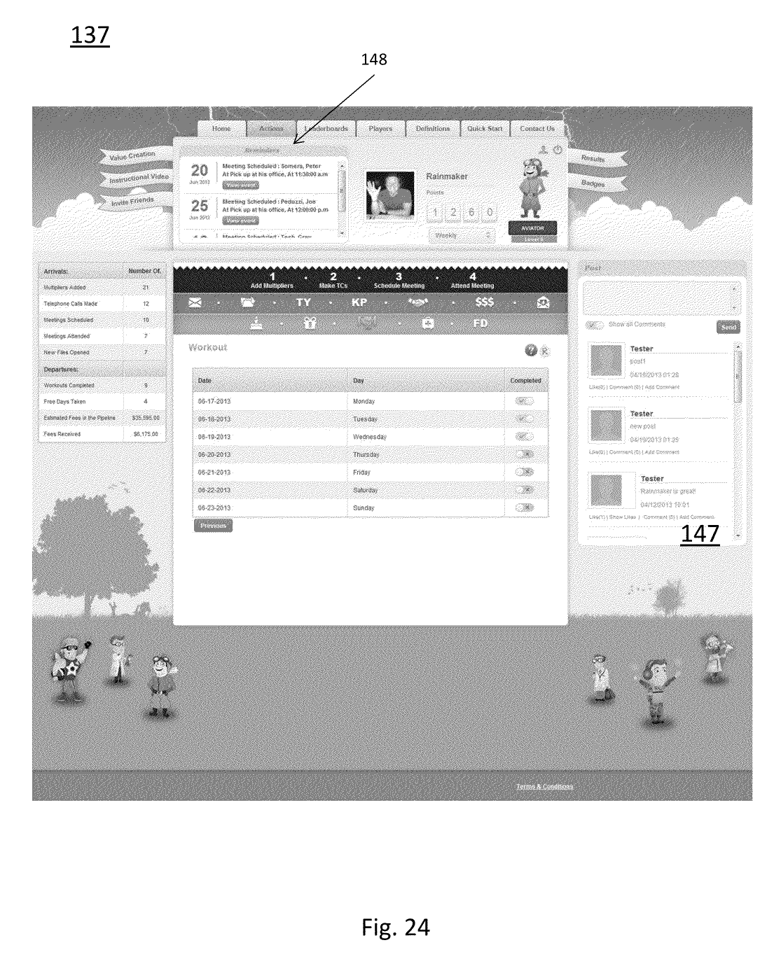

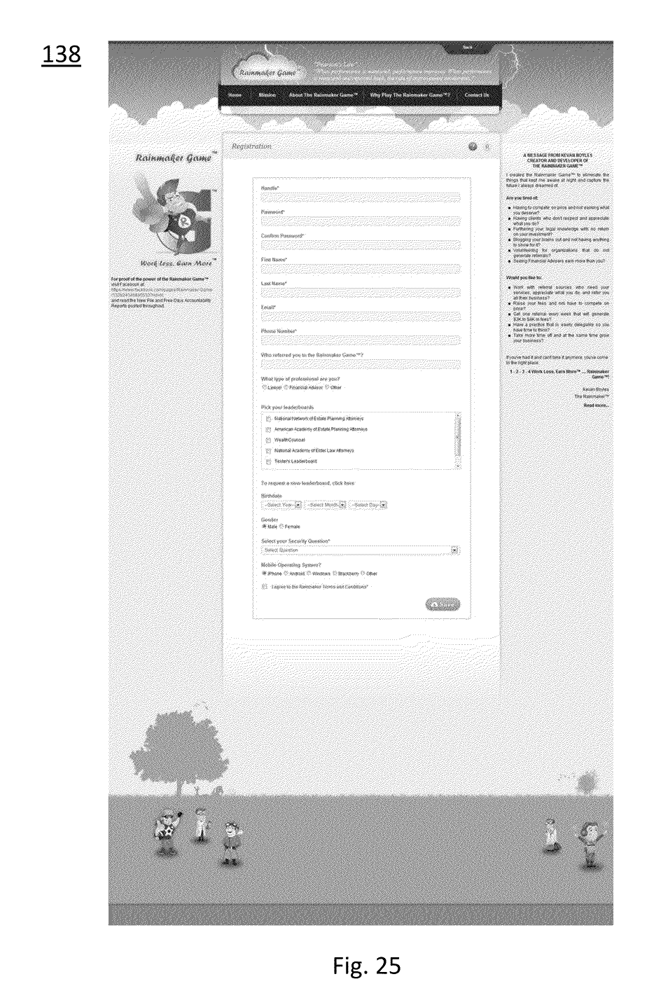

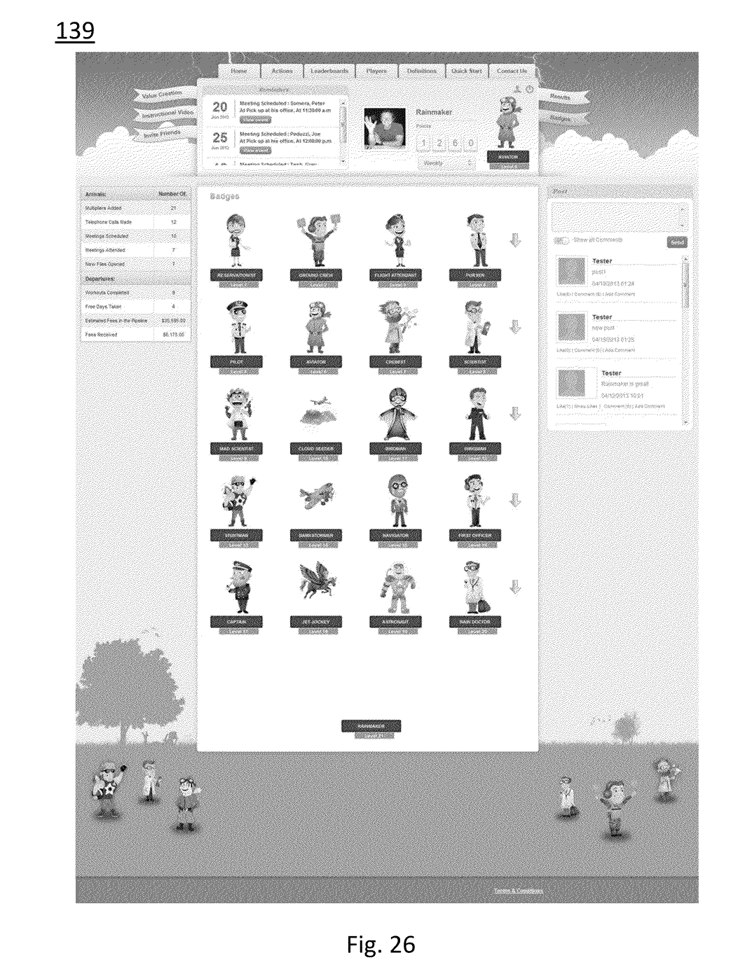

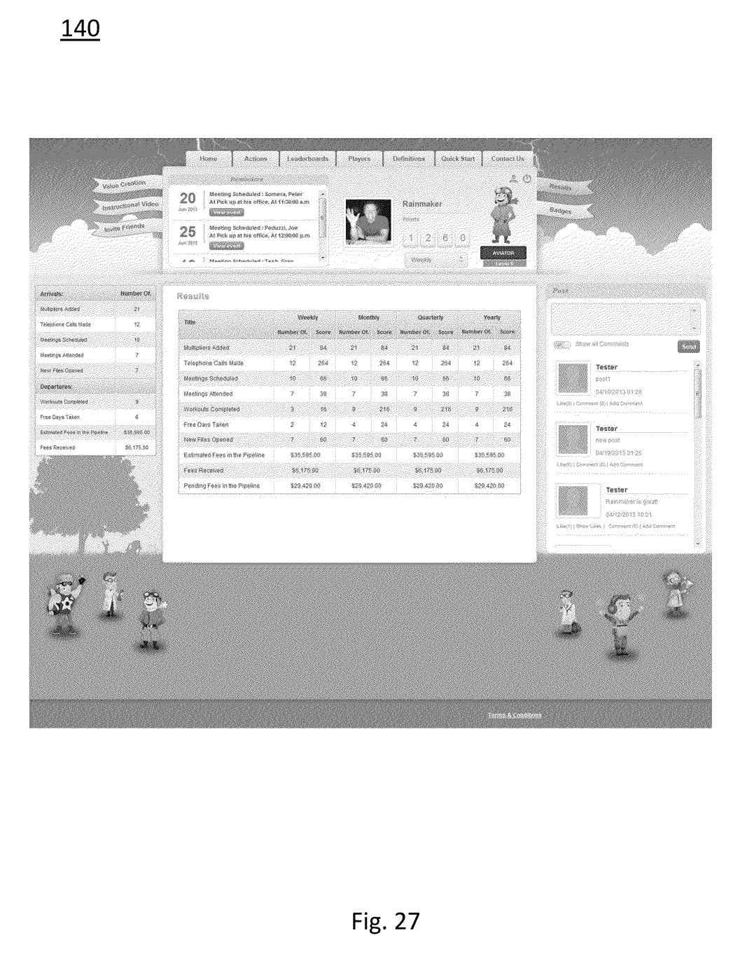

Players are also made aware of their raw score or actions by way of an arrival/departure board 141. The arrival/departure board 141 appears on every action page as shown in FIGS. 9-24. The arrival/departure board 141 provides they player with a bottom line, real number of the significant actions they have taken with respect to arrivals 142 and departures 143 and the estimate fees in the pipeline 144 and fees received on an annual basis 145.

All components are designed to work together to create, develop, and strengthen referral/sales relationships and to enhance the players' businesses and lives.

Points are scored for each action completed and each player competes against other likeminded service providers/sales representatives. The game motivates players to take consistent action on a regular basis. All results are tracked and reported. Leaderboards display those who are most effective at scoring points and obtaining results 140. Badges are earned as one improves on their results 140. Leaderboards display the leaders in the competition among players. Any player can request a new/additional Leaderboard to be created through the registration page or player profile page by clicking on the word “Other” and typing in the requested name of the new leaderboard.

In another embodiment, an administrator has the option to award players with karma points, which are additional or bonus pointed award to the user at the discretion of the administrator. Typical examples of the award of karma points would be the award of bonus points for a player's consistent evolvement in the game or contributions to the social component or feedback on making the game better.

Additionally, in another embodiment, competition among two or more leaderboards can occur. Competing leaderboards will show the number of users competing in each leaderboard; a weighting factor will be used for leaderboards competing against each other as uneven player numbers do not allow leaderboards to complete on pure total points accrued.

Software is developed using the described process and interfaces with the end player through a website on the internet. All components of the process are necessary to create the desired result. Additional components could be added to further enhance the player's success such as scoring points for following a certain diet, losing weight, having a certain amount of sleep each night, etc.

Initially, the marketing components of adding multipliers 122, making telephone calls 123; scheduling appointments 124, and attending meetings 125, as opposed to the lifestyle components of Sending birthday cards 108; Sending Thank You and Annual Gifts 109; Scheduling and attending doctor appointments 110; Completing regular physical workouts 111; and Taking regular time away from their businesses/jobs to rest and rejuvenate 112, are used in the illustrated order in one embodiment. In time, they can be used in a different order depending on individual preferences and desires in another embodiment of the present invention.

The invention is used by playing the game and following the process, by competing against other likeminded individuals, and tracking progress It can be used by any professional or nonprofessional service provider (e.g. legal, accounting, financial services, real estate, mortgage broker, etc. and also salon, carpet cleaning, yard maintenance, etc.). It can be used by organizations who wish to provide a marketing/lifestyle process to its members. It also can be used to develop any desired consistent action, inaction, or behavior for its players (quit smoking, drinking alcohol, lose weight, etc.).

From a landing page 113 users are invited to create an account to sign up for access to the method of the present invention 138. Upon successful creation of an account, comprising a player name 114 and password 115, a home page 116 is presented. The home page 116 provides information on the benefits of the method of the present invention.

Actions 121 are the steps a player takes as they progress through the method. The four core steps are: Step 1. Add Multipliers 122, Step 2. Make Telephone Calls 123, Step 3. Schedule

Appointments 124, and Step 4. Attend Meetings 125.

Multipliers 122 are a referral source, preferably one who is motivated to create a bigger future than their present. The basis of the method is to create a listing or connection to a plurality of multipliers 122 that can increase a player's business. Telephone calls 123 to a player's Multipliers 122 to schedule one-on-one meetings, whether they are breakfast, lunch, dinner, or just coffee are recorded by the system and are a key component of action for a player to increase their multipliers 122 and use them as a source for referrals. Establishing meetings by making telephone calls 123 to a player's multipliers 122 and visiting a multipliers office 136 are crucial to the success of the player. Therefore, the system tracks and provides a scoring method for encouraging and ensuring a player repeats the four basic steps 121 as much as possible

Reminders 148 appear in the upper left-hand corner of every screen. They are there to remind the users of upcoming meetings or actions to be taken.

In other embodiments, a player can be presented with pop-ups in combination with the reminder screen. In other embodiments, pop-ups can be presented to the user based on a defined listing of actions or occurrences. For example, pop-ups can be displayed to a user upon registration, welcoming them to the method and congratulating them. Other pop-ups can be used to direct a player how to begin or use the method as well as acknowledging the accumulation of points, achievement of levels and badges.

Emails can also be used to send messages to users. These emails or messages can be to all users or selected groups of users depending on the desire of the administrator in how to distribute the message and to determine which users should receive the message.

In another embodiment, a new player's initial process will begin, after registration, wherein only adding multipliers 122 is open to the player. A player must add at least three multipliers 122 before they can make a telephone call. One telephone call gives the new player the ability to schedule a meeting, and one scheduled meeting makes all actions 121 available to the player. This process is known as “on-boarding” in the computer arts and ensure that a player has a positive first experience using the system and knows the order and steps of a system, such as the complex system of the present invention.

Additional Actions 121 are designed to enhance a player's relationship with their Multipliers by adding value and to encourage them to take more time off for rest, relaxation and rejuvenation together with keeping them physically fit and in good health.

The system provides for offering the player a template of emails that can be sent using the system. Players can send template emails to other players, users, multipliers, or to a group of select users or one or more leaderboards.

A new client file 130 is opened when a player has been asked to move forward on a matter. It is different from a “referral” in that all “referrals” are considered “prospective clients” until the player is instructed to start work or has received a retainer, if applicable, in which case the “referral” becomes a new client file. This is important because all “referrals” do not become new client files and new client files are what users are interested in because of the high expectancy of receiving a check for work once they are opened.

A knowledge product 129 is a book or other tangible item that can be delivered to a Multiplier 122 to assist them in creating a bigger future and the system also provides for recording when they are sent or otherwise provided to someone by a player.

Establishing meetings by making telephone calls 123 to a player's multipliers 122 and visiting a multipliers office 136 are crucial to the success of the player. The system tracks office visits 136 a player makes to a multiplier 122.

Receive $$$ 133 facilitates the tracking of fees received on particular files/matters from a particular Multiplier 122 once the referral become a new client.

In an alternative environment, tracking of future anticipated fees is accessible by a new banner called “cash flow” that would be place with the “results” banner 145 and “badges” banners 146. This “cash flow” banner enables the tracking of future anticipated cash flow over month, quarterly, and yearly periods and provides the player with a readily identifiable and quick link to the cash flow information.

Quarterly mailings 132 are sent on a quarterly basis to a player's Multipliers 122 that are designed to provide “Top of Mind Awareness”. This could include a Knowledge Product 129 which the player has developed for their Multipliers 122 using their knowledge and wisdom. Additionally, the system keeps track of email correspondence and emails sent 134.

A Thank You note and/or gift 135 to a player's Multiplier 122 or a gift to a charity in the player's Multiplier's 122 name for making a referral can also be tracked by the system. A gift to charity doubles the points earned by the player, compared to a gift given to the multiplier 122.

With respect to Add Multipliers 122, an annual gift 126 is a gift that is made to the player's best multipliers 122 at the end of the year during the Holiday season. Birthday cards 127 are another opportunity to touch base with a player's Multipliers 122. While a handwritten note works best, the system allows a player to track birthday cards 127 sent outside the system.

Physical examinations 131 by a medical professional with the intent to preserve and protect the productivity and longevity of the player are recorded by the system of the present invention as are the player's history of workouts 137.

A free day 128 is a twenty-four hour day, midnight to midnight, during which there are no work-related activities. Rejuvenating Free Days are a necessary precondition for periods of high productivity and creativity and the system also provides for recording when they are taken.

Badges 139 are earned as a player works their way through the process. The first Badge is the Reservationist. From there the next Badge is that of a member of the Ground Crew. All Badges are based on a theme of the scientific (and not so scientific) creation of rain. Other Badges 139 include, but are not limited to, Pilot, Scientist (both sane and insane), Wingman, Jet Jockey, and of course, Rainmaker. Is important to remember that each step in the process is crucial. As a result, if a player skips steps, they will not rise in the hierarchy of the level of Badges 139.

Bonus points are earned in 3 different ways; by referring new players to the game, by progressing through the various levels or Badges 139, and through longevity of participating in the game/method. Achievement of each Badge 139 is based upon how thoroughly a player plays the game. There are twenty-one badges 139 to be earned. After a player achieves each Badge 139 every point they earn playing the game will be multiplied by an ever increasing factor.

Through longevity of playing the game points are awarded. For registering, a player receives 100 bonus points. For each month a player plays thereafter, they will receive a bonus of 20 points multiplied by the number of consecutive months they've played. For example, after the 1st month a player receives 20 points, the 2nd month 40 points, the 3rd month 60 points, etc. If for any reason a player discontinues payment and later returns to play the game they will revert back to the 1st month of 20 bonus points.

Points are scored as a player completes each Action in the process. The more Actions a player takes/makes, the more points they score. Doing certain actions more than one time may lead to the exponential accumulation of points. By way of example, if a player takes one Free Day they score one point, but if they take five Free Days in a row they score 15 points.

In another embodiment of the present invention, a user who fails to continue using the game for a period of time, typically 30 days, is presented with the option of restarting the game and losing all their points, or paying a fee and continuing the game with the points and data they have accumulated. This method is particular useful and adaptable to new users who engage the game/method for a short period of time during a free 30 day sign up period, who stop using the game, but want to come back to it at a later time. Typically, these users have entered data and accumulated points that they would not want to forfeit. This method enables the user to choose to restart and receive the initial free services that they didn't take advantage of in their previous interaction, or to pay a fee and continue engaging the method after the free introductory period.

STRENGTH FINDER 2.0 and KOLBE A INDEX assist the player in determining opportunity to do what they do best every day. STRENGTH FINDER 2.0 helps a player uncover their natural talents which often go untapped. It provides a player's five top strengths in descending order and provides insights and ideas for action for each Strength. Conscious knowledge of a player's Strengths will allow them to focus on what makes them unique in the marketplace and provide insight into why people make referrals to them. Knowledge of and developing Strengths is crucial to cloning a player's best Multipliers 122. It also helps a player to determine what things they should not be doing on a daily basis and that which should be delegated to a team member who has Strengths where they have weaknesses. Every member of their team should also take a STRENGTH FINDER 2.0 and KOLBE A INDEX to determine their individual strengths and weaknesses.

On the right hand side of the display screen a post box 147 is provide to engage players in a social aspect of the method of the present invention. The post box 147 is a news feed where users and administrators can post comments and engage in social communication.

Additionally, in another embodiment of the present invention, a symbol, such as an “R” in a raindrop is sued to link to a “Help and Wisdom” page which provide a player not only with a typical help file on how the method and process of the game works, but also provides insight or wisdom on the how and why the method and process of the game is structured with respect to business success. The wisdom component of the help screen or link would provide business advice from various sources and not only act as a help guide to using the method and process of the game, but also as a resource for learning useful tips with respect to learning more about running and managing a successful business, which is the intended goal of the method of the present invention.

The method taught by the present invention is set to run and/or executed on one or more computing devices. A computing device on which the present invention can run would be comprised of a CPU, hard disk drive, keyboard or other input means, monitor or other display means, CPU main memory or cloud memory, and a portion of main memory where the system resides and executes. Any general-purpose computer, tablet, smartphone, or equivalent device with an appropriate amount of storage space, display, and input is suitable for this purpose. Computer devices like this are well known in the art and are not pertinent to the invention.

In alternative embodiments, the method of the present invention can also be written or fixed in a number of different computer languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A method for Internet gamification of a marketing and lifestyle enhancement process, executable by a machine and rendered on the display of the machine, comprising the steps of:
registering as a player for the for the for the marketing and lifestyle enhancement process;
providing a marketing process for delivering consistent and quantifiable results by scoring points for completing specific actions during particular time periods while competing against one or more peers;
the marketing process is comprised of four action steps:
adding multipliers;
making telephone calls 123;
scheduling appointments;
attending meetings;
awarding points based on a player's actions;
scoring, tabulating, and posting points on real-time leaderboards;
providing competition between players; and
awarding badges to players as they progress through quantifiable levels of achievement.

2. The method of claim 1, wherein the marking process is further comprised of:
creating a unique list of referral/sales prospects;
contacting referral/sales prospects to schedule meetings;
attending meetings with referral/sales prospects;
providing referral/sales prospects with a consumable deliverable on a regular quarterly basis that is descriptive of the services/products available;
creating and delivering knowledge products to referral/sales prospects;
visiting referral/sales prospects' places of business;
sending birthday cards;
sending thank you and annual gifts;
scheduling and attending doctor appointments;
completing regular physical workouts, and
taking regular time away from their businesses/jobs to rest and rejuvenate.

3. The method of claim 1, wherein points are scored, tabulated, and posted in various weekly, monthly, quarterly, and annual, real-time leaderboards.

4. The method of claim 1, further comprising the steps of
creating one or more unique leaderboards by a first player;
inviting other players to the unique leaderboards; and
providing competition between players and unique leaderboards.

5. The method of claim 1, wherein competition is provided among a plurality of players organized into one or more teams from different organizations or groups.

6. The method of claim 1, further comprising the steps of
awarding points for each action completed;
tracking and reporting results;
displaying on leaderboards those who are most effective at scoring points and obtaining results; and
awarding badges as a player levels up while the player proceeds through the process.

7. The method of claim 1, further comprising the step of awarding points for following a certain diet, losing weight, having a certain amount of sleep each night, or achieve goals based on lifestyle.

8. The method of claim 1, further comprising the steps of
opening only the adding multipliers action 122 after a player's initial registration;
adding at least three multipliers before a player can make a telephone call;
providing the new player the ability to schedule a meeting after a telephone call has been made; and
scheduling one meeting makes all actions available to the player.

9. The method of claim 1, further comprising the steps of
creating an arrival/departure board;
the arrival/departure board providing the player with a valuation of significant actions taken and the estimate fees in the pipeline and fees received on an annual basis; and
displaying the arrival/departure board appears on every action page.

10. A system for Internet gamification of a marketing and lifestyle enhancement process, comprising:
at least one data storage device operable to store computer-readable instructions;
at least one computer processor operable to execute the computer-readable instructions; and
a set of computer-readable instructions operable to:
providing a marketing process;
scoring points for completing specific actions during particular time periods while competing against one or more peers;
scoring, tabulating, and posting points in real-time leaderboards;
providing competition between players; and
awarding badges as a player levels up while proceed through the process.

11. The system of claim 10, wherein the set of computer-readable instructions are further operable to:
creating a unique list of referral/sales prospects;
contacting referral/sales prospects to schedule meetings;
providing referral/sales prospects with a consumable deliverable on a quarterly basis that is descriptive of the services/products available;
creating and delivering knowledge products to referral/sales prospects; and
visiting referral/sales prospects' places of business.

12. The system of claim 11, wherein the set of computer-readable instructions are further operable to:
sending birthday cards;
sending thank you and annual gifts;
scheduling and attending doctor appointments;
completing regular physical workouts, and
taking regular time away from their businesses/jobs to rest and rejuvenate.

13. The system of claim 10, wherein points are scored, tabulated, and posted in various weekly, monthly, quarterly, and annual, real-time leaderboards.

14. The system of claim 12, wherein the set of computer-readable instructions are further operable to:
creating one or more unique leaderboards by a first player;
inviting other players to the unique leaderboards; and
providing competition between players and unique leaderboards.

15. The system of claim 14, wherein competition is provided among a plurality of players organized into one or more teams from different organizations or groups.

16. The system of claim 14, wherein the set of computer-readable instructions are further operable to:
awarding points for each action completed;
tracking and reporting results;
displaying on leaderboards those who are most effective at scoring points and obtaining results; and
awarding badges as a player levels up while proceed through the process.

17. The system of claim 16, wherein the set of computer-readable instructions are further operable to:
only adding multipliers is open to the player after a player's initial registration;
the player must add at least three multipliers before the player can make a telephone call;
one telephone call gives the player the ability to schedule a meeting; and
one scheduled meeting makes all actions available to the player.

18. The system of claim 14, wherein the set of computer-readable instructions are further operable to:
players are also made aware of their raw score or actions by way of an arrival/departure board;
the arrival/departure board providing the player with a valuation of significant actions taken and the estimate fees in the pipeline and fees received on an annual basis; and
displaying the arrival/departure board appears on every action page.

19. The system of claim 14, wherein the set of computer-readable instructions are further operable to:
awarding points for following a certain diet, losing weight, having a certain amount of sleep each night, or achieve goals based on lifestyle.

20. The system of claim 11, wherein software interfaces with the end player through a website on the internet.
